(19) United States
(12) Patent Application Publication
(10) Pub. No.: US 2018/0004762 A1
(43) Pub. Date: Jan. 4, 2018

(54) USER DISCOVERY IN A LOCATION-BASED MESSAGING PLATFORM

(71) Applicant: Quippy, Inc., San Jose, CA (US)

(72) Inventor: Alireza Jazayeri, San Jose, CA (US)

(21) Appl. No.: 15/640,285

(22) Filed: Jun. 30, 2017

Related U.S. Application Data
(60) Provisional application No. 62/356,530, filed on Jun. 30, 2016.
(60) Provisional application No. 62/356,531, filed on Jun. 30, 2016.
(60) Provisional application No. 62/356,532, filed on Jun. 30, 2016.
(60) Provisional application No. 62/356,533, filed on Jun. 30, 2016.

(51) Int. Cl. G06F 17/30; H04L 29/08; G06F 3/0484

(52) U.S. Cl. CPC G06F 17/3087; H04L 67/18; G06F 3/04842

(57) ABSTRACT

Aspects of invention relate to a system for providing nearby accounts. The system architecture may include: a computer processor; a live discovery module executing on the computer processor and configured to enable the computer processor to: receive, from a client device, a request for nearby accounts, the request identifying a context account of a social media platform and a corresponding client geographic location; identify a set of accounts of the social media platform within a density-based geohash region corresponding to the client geographic location; rank the set of accounts according to a plurality of geographic distance tiers, wherein the geographic tiers are used to categorize the set of accounts based on a distance between the client geographic location and each account's geographic location, a plurality of recency tiers, wherein the recency tiers are used to categorize the set of accounts based on a recency of each account's geographic location data, a plurality of accuracy tiers, wherein the accuracy tiers are used to categorize the set of accounts based on an accuracy level of each account's geographic location data; generate, based on ranking the set of accounts, a result set identifying a subset of the set of accounts; and provide the result set in response to the request.

### CROSS-REFERENCE TO RELATED APPLICATIONS

This application claims benefit of U.S. Provisional Patent Application No. 62/356,530 (attorney docket #: quippy.00001.us.p.1), filed on Jun. 30, 2016 and entitled “CONTENT DELIVERY IN A LOCATION-BASED MESSAGING PLATFORM,” U.S. Provisional Patent Application No. 62/356,531 (attorney docket #: quippy.00001.us.p.2), filed on Jun. 30, 2016 and entitled “USER DISCOVERY IN A LOCATION-BASED MESSAGING PLATFORM,” U.S. Provisional Patent Application No. 62/356,532 (attorney docket #: quippy.00001.us.p.3), filed on Jun. 30, 2016 and entitled “ARBITRARY BADGING IN A SOCIAL NETWORK,” and U.S. Provisional Patent Application No. 62/356,533 (attorney docket #: quippy.00001.us.p.4), filed on Jun. 30, 2016 and entitled “ONSITE DISPLAY IN A LOCATION-BASED MESSAGING PLATFORM.” U.S. Provisional Patent Application Nos. 62/356,530, 62/356,531, 62/356,532, and 62/356,533 are incorporated by reference herein, in their entirety.

This application is related to the following copending U.S. patent applications: (1) U.S. patent application Ser. No. ______, entitled “CONTENT DELIVERY IN A LOCATION-BASED MESSAGING PLATFORM,” and filed on Jun. 30, 2017, (2) U.S. patent application Ser. No. ______, entitled “ARBITRARY BADGING IN A SOCIAL NETWORK,” and filed on Jun. 30, 2017, and (3) U.S. patent application Ser. No. ______, entitled “ONSITE DISPLAY FOR A LOCATION-BASED MESSAGING PLATFORM,” and filed on Jun. 30, 2017. Copending U.S. patent application Nos. ______, ______, and ______ are incorporated by reference herein, in their entirety.

### BACKGROUND OF THE INVENTION

Hyperlocal and location-based social media platforms face unique challenges in identifying, aggregating, and delivering content. The majority of such platforms have historically targeted a consumer audience and have failed to generate the incentives necessary for a self-sustaining network effect. Many technical challenges associated with constraints of consumer clients and backend services have resulted in a lack of proliferation of location-based social platforms.

### BRIEF SUMMARY OF THE INVENTION

In general, in one aspect, the invention relates to a system for providing nearby accounts. The system includes: a computer processor; a live discovery module executing on the computer processor and configured to enable the computer processor to: receive, from a client device, a request for nearby accounts, the request identifying a context account of a social media platform and a corresponding client geographic location; identify a set of accounts of the social media platform within a density-based geohash region corresponding to the client geographic location; rank the set of accounts according to a plurality of geographic distance tiers, wherein the geographic tiers are used to categorize the set of accounts based on a distance between the client geographic location and each account's geographic location, a plurality of recency tiers, wherein the recency tiers are used to categorize the set of accounts based on a recency of each account's geographic location data, a plurality of accuracy tiers, wherein the accuracy tiers are used to categorize the set of accounts based on an accuracy level of each account's geographic location data; generate, based on ranking the set of accounts, a result set identifying a subset of the set of accounts; and provide the result set in response to the request.

In general, in one aspect, the invention relates to a system for organizing hangouts. The system includes: a computer processor; a hangouts organization module executing on the computer processor and configured to enable the computer processor to: receive, from a first user, a hangout definition comprising a hangout time, a hangout duration, a hangout location, a public designation, and a set of invited participants; send invites to the invited participants on behalf of the first user; receive confirmation from a subset of the invited participants and designating the subset of the invited participants as confirmed participants; receive a request for nearby content from a second user not among the set of invited participants; identify a set of users based on proximity to a device of the second user; determine that a subset of the users are among the set of confirmed participants; group the subset of the users with data associated with the hangout definition; and provide, in response to the request, the grouped subset of the users and the data for display in a user interface of the second user.

In general, in one aspect, the invention relates to a method for providing nearby accounts. The method includes: receiving, from a client device, a request for nearby accounts, the request identifying a context account of a social media platform and a corresponding client geographic location; identifying a set of accounts of the social media platform within a density-based geohash region corresponding to the client geographic location; ranking the set of accounts according to a plurality of geographic distance tiers, wherein the geographic tiers are used to categorize the set of accounts based on a distance between the client geographic location and each account's geographic location, a plurality of recency tiers, wherein the recency tiers are used to categorize the set of accounts based on a recency of each account's geographic location data, a plurality of accuracy tiers, wherein the accuracy tiers are used to categorize the set of accounts based on an accuracy level of each account's geographic location data; generating, based on ranking the set of accounts, a result set identifying a subset of the set of accounts; and providing the result set in response to the request.

In general, in one aspect, the invention relates to a method for organizing hangouts. The method includes: receiving, from a first user, a hangout definition comprising a hangout time, a hangout duration, a hangout location, a public designation, and a set of invited participants; sending invites to the invited participants on behalf of the first user; receiving confirmation from a subset of the invited participants and designating the subset of the invited participants as confirmed participants; receiving a request for nearby content from a second user not among the set of invited participants; identifying a set of users based on proximity to a device of the second user; determining that a subset of the users are among the set of confirmed participants; grouping the subset of the users with data associated with the hangout definition; and providing, in response to the request, the grouped subset of the users and the data for display in a user interface of the second user.

In general, in one aspect, the invention relates to a non-transitory computer-readable storage medium comprising instructions for providing advertising content. The instructions, when executed on at least one computer processor, enable the computer processor to: receive, from a client device, a request for nearby accounts, the request identifying a context account of a social media platform and a corresponding client geographic location; identify a set of accounts of the social media platform within a density-based geohash region corresponding to the client geographic location; rank the set of accounts according to: a plurality of geographic distance tiers, wherein the geographic tiers are used to categorize the set of accounts based on a distance between the client geographic location and each account's geographic location, a plurality of recency tiers, wherein the recency tiers are used to categorize the set of accounts based on a recency of each account's geographic location data, a plurality of accuracy tiers, wherein the accuracy tiers are used to categorize the set of accounts based on an accuracy level of each account's geographic location data; generate, based on ranking the set of accounts, a result set identifying a subset of the set of accounts; and provide the result set in response to the request.

Other aspects of the invention will be apparent from the following description and the appended claims.

### BRIEF DESCRIPTION OF THE DRAWINGS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

Embodiments of the present invention are illustrated by way of example, and not by way of limitation, in the figures of the accompanying drawings and in which like reference numerals refer to similar elements.

FIGS. 1A and 1B show schematic diagrams of systems, in accordance with one or more embodiments of the invention.

FIGS. 2A-2C depict example user interfaces showing friends-only and merged (friends+nearby) streams, in accordance with one or more embodiments of the invention.

FIG. 3 depicts an example user interface displaying users nearby, in accordance with one or more embodiments of the invention.

FIGS. 4A and 4B depict example user interfaces displaying creation of a new hangout, in accordance with one or more embodiments of the invention.

FIGS. 5A and 5B depict example user interfaces displaying hangouts and users in a nearby view, in accordance with one or more embodiments of the invention. Functionality such as chat can be enabled based on social or distance proximity, as displayed.

FIGS. 6A and 6B depict example user interfaces displaying a hangout in a location-based social media stream, in accordance with one or more embodiments of the invention.

FIGS. 7A and 7B depict example user interfaces displaying hangouts in a user's social network (7A) and hangouts nearby (7B), in accordance with one or more embodiments of the invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

In general, embodiments of the invention provide methods and systems related to location-based social networking systems and architecture.

“Live” User Discovery

Live User Classification: We can use the location info factors (for example, a location's proximity, a recency rating, and an accuracy rating) of other users' client device location info to determine how we surface those users to you.

Location Info Reliability: We determine the reliability of users' location info based on various inputs (for example, location coordinates, the accuracy of the coordinates, and the recency of the coordinates). There are various levels of reliability depending on various factors. “Live” can mean that we have a reasonable level of certainty that the user is nearby (mostly based on recency). The info may not be truly “live” depending on the recency.

For example:

(i) A user's app requests a stream. The platform then determines which users are within a radius (e.g., 50 miles).

(ii) If any of these users have asked to be not discoverable, the platform removes those users from the set.

(iii) If for any users the current location info is beyond the level 2 threshold (24 hrs stale, discussed below), the platform removes those users from the set.

(iv) The remainder are divided into “buckets” (aka classes/categories), which is useful for ordering the results for display to the user.

Ordering Factors—Distance

The proximity of other users is considered. For example, users that are very proximate (e.g., at the current location of the user or within 100 meters) are included at the top of the result set. Remember, density-based geohashing is used here (backend)

Ordering factors—Recency

Even if location data shows a user is very nearby, the staleness of the location coordinate can be considered (e.g., what if the timestamp was 72 hrs ago). The following are example thresholds: Level 1 threshold (e.g., 25 min). If coordinates are older than 25 min, don't ever show that the user is accurately nearby, call it fuzzy. Level 2 threshold (e.g., 24 hrs). Drop dead threshold. We have no idea where this user is, they could have died for all we know.

Ordering factors—Accuracy

The accuracy of the location data can also be considered. Accuracy pertains to the accuracy of the geographic coordinates (not the timestamp in most embodiments). A client device operating system provides the coordinates and tells you how accurate they are (within 5 meters, within a region, etc.).

For example: If retrieved while an app is in foreground mode, we know the location info is very precise (probably retrieved from GPS receiver of the device). If app's location received while app in the background, we know it's fuzzy because we want to minimize battery consumption.

Accurate (aka precise) vs Not Accurate (aka fuzzy): In descending order: Pinpoint accuracy, GPS level accuracy, Wifi accuracy, Cell tower triangulation.

Foreground location updates: Basically whenever using the app. Rate-limited to minutely. These can have near pinpoint accuracy, or more precise accuracy.

Background Location Updates

iOS Significant Location Change: If there's a change of location roughly beyond a threshold (set by the app but not fully honored by the OS), wake up my app and notify me. Can also poll for location every 15 min regardless.

iOS Region Monitoring: Similar to geofencing. Wake me up if the user leaves this threshold of a range (specified by app) AND give me a location that is X level of accuracy (pre-specified levels). We intentionally lower accuracy to lower battery consumption.

Android platform is similar but different (range+accuracy).

Buckets

The following are example buckets, which may be used for ordering display of other users to the user:

“Here” bucket:
Rule: Friends AND/OR strangers, 100 meters (distance), within level 1 recency threshold (recency), and have precise coordinates (accuracy).
Stranger=Not friends/not connected/not following. A user can have different levels of affinity towards a non-friend account. For example, proximity to a geographic location or event can be used as a signal to surface content.

“Tier I Friends” bucket:
Rule: Remainder of friends outside of above bucket, within 5 miles (distance), and precise (accuracy).
Distance indication is rounded up to the nearest mile.

“Tier II Friends” bucket:
Rule: Remainder of friends outside of above bucket (which is not within 5 miles (distance) OR not precise (accuracy))
Distance indication shows the city name instead of miles.

“Not Friends” bucket:
Rule: Every other user remaining in the set (which is not your friend, not within 100 meters, or not friend and has fuzzy location data)
This person could be literally 10 meters from you but the data is fuzzy.
If not friends, we don't want the app to be a homing beacon (eg, drive around until you find the person), so don't show the distance but instead just the city name. So we only show line-of-sight distances.

Anti-Spam Functionality

This is somewhat related to live user discovery.

Problem: Most/all social media platforms prevent non-connected users (users that aren't “friends” or “following”) to contact each other (eg to avoid spam).

Solution: Because we implement live/nearby user discovery, we allow such non-connected user messaging because it's already filtered down by the location proximity requirement. So if a non-connected user appears in any of your buckets (or top 2 buckets or however we decide to implement it), messaging is allowed with such users but not the rest of the users. Therefore, it's a built-in spam prevention mechanism. So now non-connected users can communicate. For example, when at a concert, 4 guys can direct message a girl. If she “friends” one of the guys, when she leaves and goes home, she can continue communicating with that friend. Meanwhile the 3 others guys can no longer message her.

Hangouts

In one embodiment, a hangout is a calendar-like utility. The system allows users to schedule “hangouts” (meet ups/meetings/hang out sessions) involving other users and/or non-users, and communicate with the members of the hangout to do more casual engagements. In one embodiment, this is better than a group text among multiple friends to determine plans for an evening.

Non-user invitation: A user with an account on the social media platform may invite a person without an account. The platform may provide an invite code that the new user uses to sign up. That invite code can be used to track the conversion. Also, that invite code can be used to determine that this new user is the user's friend (e.g., to connect them).

Hangouts in the Nearby Tab

Current Hangouts

The Nearby tab can show you nearby hangouts that are in progress (in addition to which other users are nearby).

Because the hangout may be scheduled beforehand, the tab may show a hangout an amount of time before the hangout start time or and amount of time following the hangout end time.

The tab can also show you various info about the hangouts (location, category, RSVP′ d and/or attending users, etc.).

The tab may not show every scheduled hangout, but instead filter some hangouts. For example, based on how many people are actually present at the hangout (e.g., maybe 30 people accepted the hangout but only 1 has shown up).

The tab may show the users of the hangout grouped near one another and with an indication hat the users are together (e.g., a surrounding bubble). Even if the creator of the hangout isn't there.

So it's still realtime user discovery.

Chat functionality with the members of the hangout (e.g., a chat button) may be provided to all users or only those users that have already joined.

A hangout can be private to the invited users or publicly viewable to all users (optionally limited to nearby users)

A hangout may be automatically joined by any users. Or, a hangout even if publicly viewable, may require a user to request to join. In the latter case, either the owner (or another member) could approve.

A hangout may allow any member to invite other members, or may only allow creators/administrators to invite other members.

The nearby tab may show hangouts sorted to the top of the page with respect to nearby users in pagination. Or the nearby tab may show hangouts sorted with nearby users of the page in pagination.

Future Hangouts
Hangouts that are scheduled to begin in the future (e.g., between 1-24 hrs).
May be its own item rather than a grouping of users.
May show less information (e.g., doesn't make sense to show members in attendance yet).
Sorts with the users based on proximity, but doesn't need to be.

Hangouts in the Hangouts Tab
In some embodiments, a tab or page dedicated to hangouts may be provided, where only hangouts are shown without nearby users.
Currently in progress and/or future hangouts may be shown.
The page may allow hangouts to be joined or simply discussed (with or without joining).
The hangouts may be ordered by proximity to your location.

Hangouts in the Stream Tab
Hangouts that are to commence in the near future (e.g., in 1 hr) may be shown in a message post form in the stream.
Because the hangout is in “post” form, other users may be able to make comments, like, share, etc.
The social media platform provider may be the author. The creator, administrators, or members of the hangout may be the author(s).

### FIGURES

1) User Streams: this is a repository that includes a data structure representing a stream of data for each user. This stream includes only data from friends and followed accounts initially. The Message Ingestion Service copies each message that is posted by a user into their followers/friends streams as they are posted. This is how the streams are updated in realtime as messages are “ingested” by the system. Nearby data is not added to the stream until it is requested by a user. In other words, if a user client requests their stream the Stream Generation Module fetches it from the User Streams Repo and then merges it with nearby data from the User Content Graph in realtime, then serves the merged data to the user client.

2) The clustering Engine: a distributed offline service that takes user content from the User Content Graph and groups that data into Hotspots. These hotspots, which are the output of the clustering process are stored in the Hotspots Repo.

The clustering engine begins by segmenting the clustering work geographically. Since the data in the User Content Graph is stored in a density-based geohash tree structure, the Clustering Engine can select leaf nodes of the tree (or select a fixed number of hops above the leaf nodes) in order to grab a quasi-fixed size chunk of data from a variable sized geographic region.

So some regions may be dramatically different in geographic size, but should represent some upper bound in terms of content size (i.e., number of content items).

Let's call the selected region R. The next thing that the Clustering Engine does is to grab leaf nodes of the density based geohash tree that cover the perimeter of region R.

These surrounding regions may also be of variable geographic size

Let's call the resulting region F=R (selected region)+N (neighboring regions). This resulting region F is passed to a worker service of an elastic computing cluster for analysis.

So the initial identification of the multiple F regions happens by a Master Clustering Service which then passes the F regions to multiple worker services. Each worker service performs the actual clustering on its respective region. The clustering we perform is fixed-radius clustering, but any type of clustering algorithm may be used. For example, K-means clustering or other types of clustering may be performed. Fixed radius clustering is preferred because it represents variable number of clusters of fixed (or semi-fixed) geographic size.

Once each worker completes clustering it returns the result of the clustering (a set of identified clusters) to the Master Clustering Service (MCS). The MCS the obtains the results from each worker and performs a deduplication. Deduplication means that if there are any 2 clusters that overlap, we delete the one with the lower density. Deduplication is necessary because the regions were deliberately selected to overlap, in order to prevent edge cases where a cluster overlaps two workers' regions. Since the regions overlap (by virtue of the fact that we selected perimeter neighbors), the cluster will be identified by at least 1 of the workers in full.

The MCS then stores the deduplicated results in the Hotspots Repo.

Again, the Clustering Engine includes the MCS and the workers, which are implemented in an elastic computing cluster.

The clustering engine performs the clustering and overwrites the data in the Hotspots repo periodically (eg, every 5 minutes). This way the clusters stay current and the data that is posted by users makes it into a cluster within at most 5 minutes of time (+clustering runtime).

The Hotspot Delivery module (HDM) obtains requests from clients, each request including a location of the client. The HDM then fetches a set of the hotspots from the Hotspot Repo that are closest to the client location. The Hotspots in the Hotspot Repo are also stored by their geohash value, and are also stored in a density-based geohash tree. This way, we can fetch hotspots only in the leaf node region of the tree (plus neighbors), order them by proximity to the client, and return a predefined number of them in response to the request.

3) The Social Graph Repo: this stores the relationships (both bi-directional and directed edges) between accounts. These represent followers, friends, or other types of relationships. This data is used by the Message Ingestions Service to create and store the streams (connect that edge also MIS <−> Social Graph).

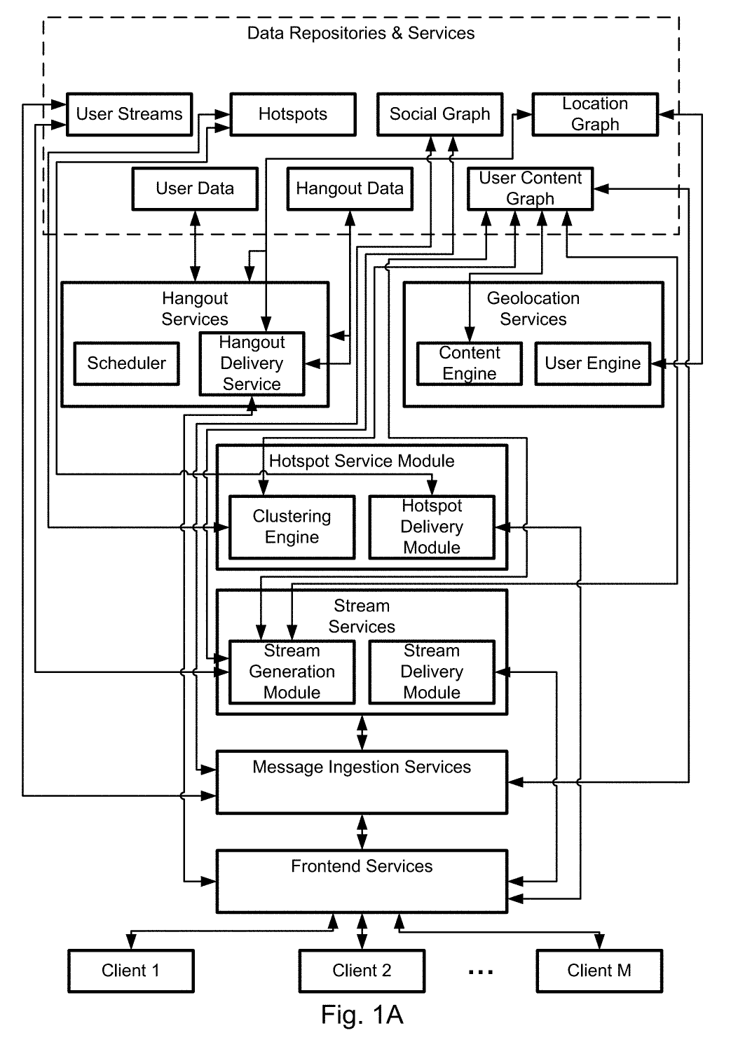

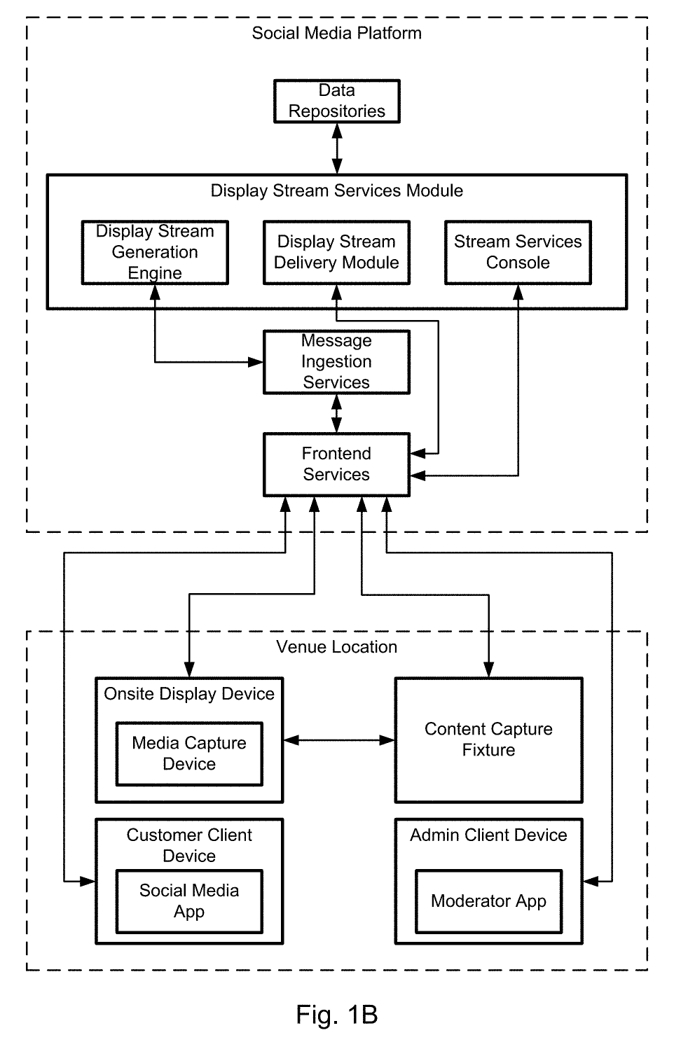

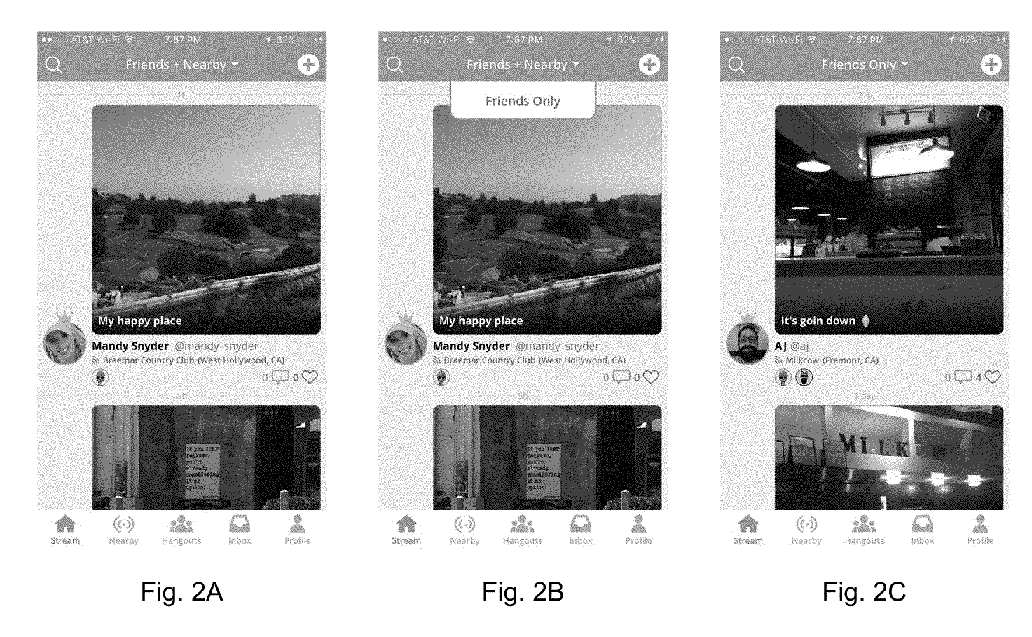

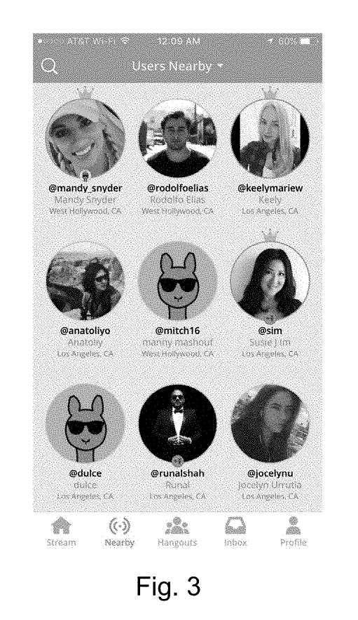

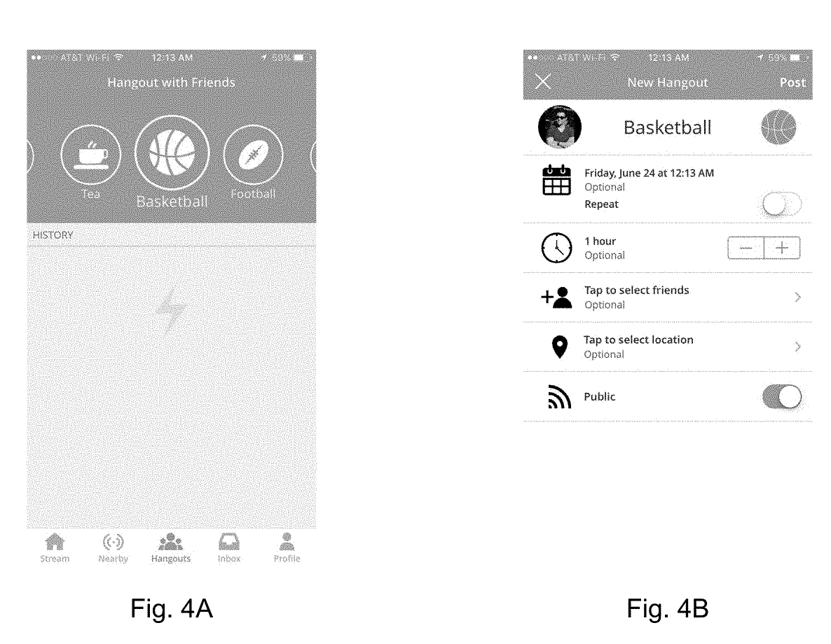

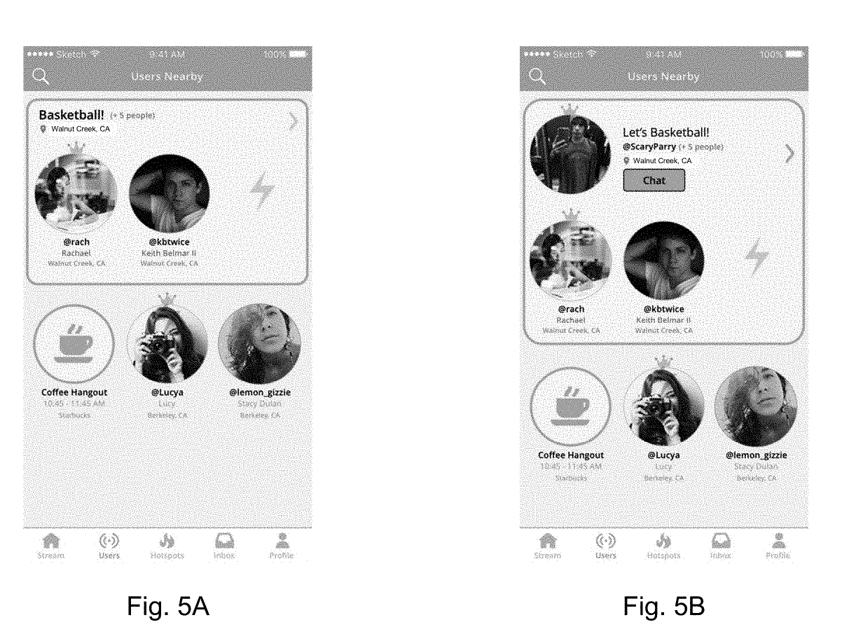

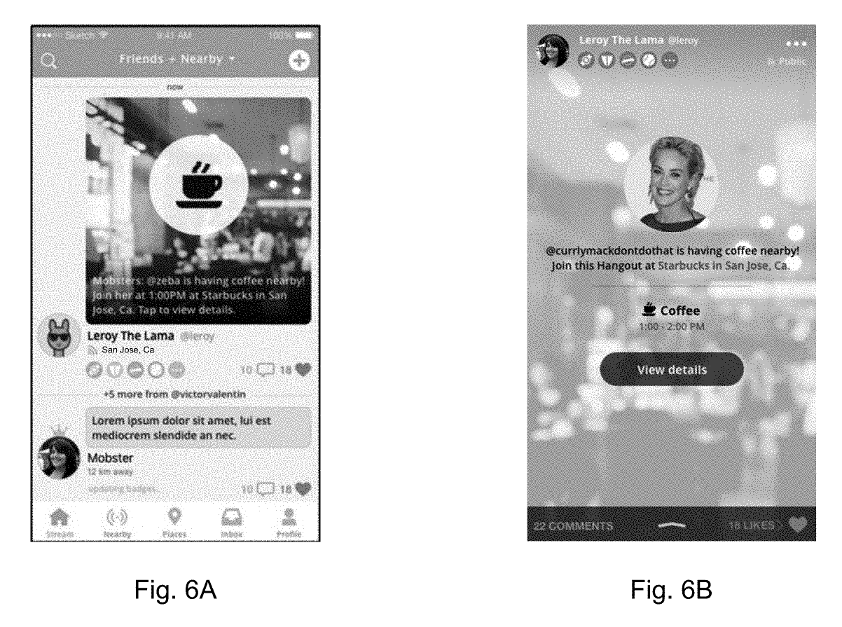

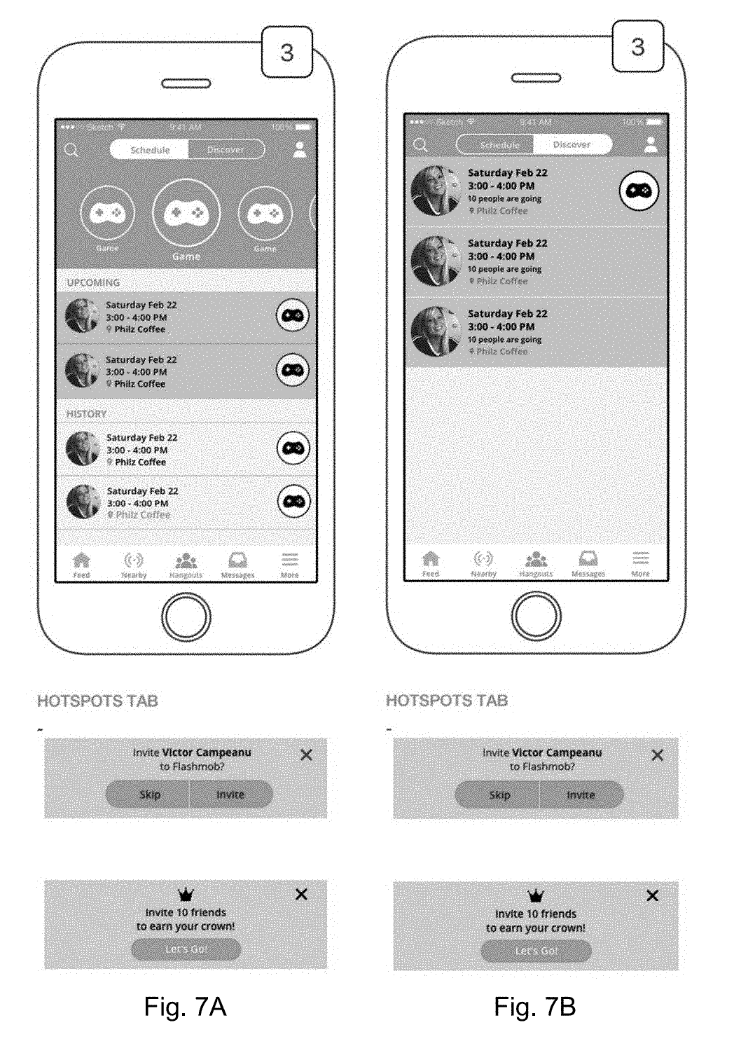

4) User Data simply stores the name, display name, and other account attributes of each user. Even though not shown, this data is used by most of the services of FIG. 1A.

5) Hangout Data Repo: this stores the details of each Hangout created by our users. Again, there may be other data repos within this repository that include necessary Hangout data.

6) Hangout Services: this is a collection of services that schedules, creates, modifies, and delivers hangouts in response to user requests. This includes a Scheduler which schedules Hangouts and generates notifications when users are invited, join, leave otherwise interact with hangouts.

Hangout Delivery Module fetches hangout information from both the Location Graph and the Hangout Data Repo and returns that data in response to client requests.

7) Location Graph Repo: this is one of the most important repositories in the system. This Repo stores objects representing the location of physical entities in a density based geohash tree structure. An object in the Location Graph can include: a user object representing the last known location of a user, a hangout object representing the location of a hangout, a venue object representing the location of a physical location (eg, a business, an event) and etc.

Each object can also include an effective date/time/duration representing when it is active. For example, once a hangout is over it would no longer be active.

Or, the timeouts for user objects would dictate how or when they are surfaced to other users (as described in the “live user discovery” algorithms).

Geolocation Services Module may periodically prune/remove stale data from the Location Graph Repo as desired.

Next topic will be how Hangout, user, and venue objects are stored in the Location Graph Repo and why that data needs to be duplicated.

So, let's start with user data in the Location Graph Repo. The Flashmob app on the user device has a background location monitoring engine (BGE) that uses the operating system API to track the user's location even when they aren't using the app. In iOS there are two methods of doing this: one is called significant location change and the other is region monitoring. Either can be used. The premise is that the BGE tracks the user's location and sends updates of the location to the Frontend Service which then relays the updates to the Geolocation Services Module. There is an object representing the user in the Location Graph Repo, and the User Engine of the Geolocation Services Module updates that user's location in the Repo. This location is stored as a geohash value. There is a Geohash Tree Engine (GTE) that is not shown, which balances all of the geohash trees and handles insertion, removal, and update of content in the tree. If the new geohash value changes from one leaf node of the density-based geohash tree to a different leaf node, the GTE performs a rebalance of the tree. The GTE performs this rebalance by basically leaving the old user object but marking it for removal (inactive) and just adding a new user object with the new geohash value. There is a periodic process which essentially “rebuilds” the geohash tree and prunes the old geohash values. In an alternate implementation, a recursive algorithm restructures the tree on-demand to maintain balance.

This maintenance of the density-based geohash tree (DBG tree), along with the GTE applies to all DBG trees in the system including the User Content Graph, and the Hotspots DBG tree in the Hotspots repo.

(although the Hotspots do not typically require insertion and removal with the exception of manual curation by and administrator, removal of NSFW content, regional blacklisting, etc)

Hangout objects in the Location Graph Repo are similarly stored. There are different consumption experiences in the client application that require different usages of this Repo. The main ones are: Nearby User Discovery, Hangouts Discovery, Venue Discovery, and hybrids of one or more of them. The term “live user discovery” can refer to any of the aforementioned and is not strictly limited to user objects. So, in nearby user discovery for example, the Geolocation Services Module gets a request to fetch nearby users for a client. The location of the client is used to identify a search region R (including perimeter neighbors), all active users in R are ordered by proximity to the client, and the closest X users (depending on requested page size) are returned to the client in response to the client request.

In the hybrid approach, a single view in the client application can display any of the three object types in the same result set, ordered by proximity to the client.

One important point about the DBG trees is that they include replicated data (for performance reasons). In other words, each DBG tree node includes all data required for its respective consumption experience. For example, user objects include username, display name, profile thumbnail URL, and a subset of other user attribute data that is already stored in the User Data Repo. Updates to the User Data Repo must therefore also be made to the Location Graph Repo and vice versa to maintain consistency. In this way, a single query to the Location Graph Repo can quickly fetch results with no external dependency.

For example, given a geohash aerial view, each of the various devices on the map have a distance, recency, and accuracy value. Those values can be used to determine which bucket they fall into. Based on the bucket, certain accounts can be suggested, or their content can be included in the context account's timeline.

Server

Clustering algorithm, one embodiment showing pseudocode of the base implementation:

Function frnn(D, radius)

1. Pick a point at random, call it p

2. Let the initial set of clusters be the set which contains only the one point cluster {p}. That is, let Clusters={{p}}

3. For every x in D do

a. For every C in Clusters calculate the proximity of x to C

b. If promity of x is greater than radius for every C in Clusters then add a new one point cluster {x} to Clusters.

c. Otherwise find the cluster C such that proximity(x,C) is minimal and add x to that cluster.

Lastly, return Clusters

Parameter Selection

(i) Select a minimum depth of Min=3 for adjacency grouping, ie, we only select adjacent geohashes for regions that have at least a depth of 3. Any leaf nodes above the Min depth would still be clustered but without including adjacent neighbors. Min depth prevents selecting adjacent geohashes for regions that are too large.

(ii) Let's select a Max depth of 4. Max depth defines the most granular region for clustering.

Algorithm:

(Step 1) Identify the set of unique geohash values in the database as set G.

(Step 2) Select an unmarked geohash value from G as a cluster region.

(Step 3a) If the cluster region is lower than depth 4 (Max), truncate the region's geohash to expand the cluster region to a depth of 4.

(Step 3b) If the cluster region is at least at depth 3, expand the cluster region to include adjacent perimeter geohashes (eg, P1 . . . P8). There may be any number of adjacent geohashes depending on the depth of the tree at those areas.

(Step 4) This resulting cluster region is R. Tag all posts that are in the final cluster region (R). Go to step 2.

(Step 5) Cluster the points in each of the regions R in parallel. For each identified cluster, store the 6-digit geohash value (V) of the centroid of the cluster (easy to calculate from the lat/long of the centroid).

(Step 6) Take the resulting clusters and deduplicate them.

Deduplication Algorithm:

(Step 1) Select an unmarked cluster C

(Step 2) Create a comparison set S that includes: (Step 2a) all clusters having a matching 6-digit geohash value (V) to C, (Step 2b) all clusters in any one of the 8 neighboring regions to V

(Step 3) Compare each cluster in the comparison set S to every other cluster in S. For any two clusters that have a centroid within 500 meters of one another, delete the lower density cluster. Mark all remaining clusters in S. Proceed to step 1. Alternately, we can simply compare geohash values of the centroids to identify overlapping clusters (ie, compare geohashes with sufficient geohash similarity to know they are within X distance).

Geohash Tree:

(Step 1) Construct density-based geohash tree with density threshold=50, max depth of tree=9 (example values)

(Step 2) Ingest newly posted messages into tree immediately upon posting (by spawning threads on-demand)

Removal of Posts from the Tree (Periodic Batch Process):

(Step 1) Flag all posts older than 24 hours for removal from the tree. When a user wants to delete a post, it should be flagged in the same manner. This way the next batch process will remove it from the tree.

(Step 2) Select a flagged post. If none exist, end. Also select the following: (Step 2a) all flagged posts that have the same geohash, (Step 2b) all flagged posts that have the same parent (must be same length geohash)

(Step 3) Identify the parent of the selected posts from step (2) (all must have the same parent). Check the database for ANY posts having this parent which also have a longer geohash string than the selected posts (number of characters). If any posts are found with a longer geohash string, delete all of the selected posts (from step 2) and continue to step 2. Else continue to step 4.

(Step 4) Count the selected posts to get a removal count (R). Find the number (N) of all non-selected posts having (i) same length geohash string and (ii) same parent as the selected posts. If (N-R) is less than the geohash max node threshold (in our example 50) truncate a digit from the geohash of all non-selected posts counted in N. Delete the selected posts and proceed to step 2.

Feed Algorithm:

Separate endpoints for pull-to-refresh and auto-refresh:

Pull-to-refresh (PTR)

Part 1: identifying the search region(s)

(Step 1) Receive a client request with a stream location (S)

(Step 2) Identify the geohash of the leaf node containing S. If the leaf node includes >50 posts (ie, it is a lowest level leaf of the tree with more than 50 posts), select the leaf node as N. Else, step up one level and select the parent node as N (sanity check: make sure the parent has at least 20 points).

(Step 3) Identify 8 perimeter geohash values (P1 . . . P8) for regions surrounding N

(Step 4) Within each of P1 . . . P8, select leaf nodes of the tree which (i) are adjacent to perimeter of N and (ii) have at least one content item

(Step 5) The resulting selected leaf nodes+N comprise the global search region (R) for the query

Part 2: producing a result set

(Step 1) Score and rank all posts in the search region R using Score=A+0.69*B, where A is distance (meters) of the post from the stream location and B=age of post (seconds). Before scoring, ignore any posts in Z={posts already seen by the client} and Y={posts by blocked/muted users}

(Step 2) Return the 30 highest ranking posts.

Notes: The entire messages repository (and Z) are pruned periodically to remove items older than 12 hours

Auto-Refresh

In one embodiment, for auto-refresh the system fetches up to 30 nearest posts, only from nearby users (<500 m).

Client

Auto-refresh: In one embodiment, only perform auto-refresh if the scroll area is within 5 messages of the most recent (top-most) message

For purposes of this disclosure, the terms messaging platform, social media platform, and social network may be used interchangeably.

Various system configurations: Although the components of the systems are depicted as being directly communicatively coupled to one another, this is not necessarily the case. For example, one or more of the components of the systems may be communicatively coupled via a distributed computing system, a cloud computing system, or a networked computer system communicating via the Internet.

Various system configurations: It should be appreciated that one computer system may represent many computer systems, arranged in a central or distributed fashion. For example, such computer systems may be organized as a central cloud and/or may be distributed geographically or logically to edges of a system such as a content delivery network or other arrangement. It is understood that virtually any number of intermediary networking devices, such as switches, routers, servers, etc., may be used to facilitate communication.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

For example, a computing system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), a bus, and numerous other elements and functionalities. The computer processor(s) may be an integrated circuit for processing instructions. For example, the computer processor(s) may be one or more cores or micro-cores of a processor.

In one or more embodiments, the computer processor(s) may be an integrated circuit for processing instructions. For example, the computer processor(s) may be one or more cores or micro-cores of a processor. The computer processor(s) can implement/execute software modules stored by computing system, such as module(s) stored in memory or module(s) stored in storage. For example, one or more of the modules described in the figures can be stored in memory or storage, where they can be accessed and processed by the computer processor. In one or more embodiments, the computer processor(s) can be a special-purpose processor where software instructions are incorporated into the actual processor design.

The computing system may also include one or more input device(s), such as a touchscreen, keyboard, mouse, microphone, touchpad, electronic pen, or any other type of input device. Further, the computing system may include one or more output device(s), such as a screen (e.g., a liquid crystal display (LCD), a plasma display, touchscreen, cathode ray tube (CRT) monitor, projector, or other display device), a printer, external storage, or any other output device. The computing system may be connected to a network (e.g., a local area network (LAN), a wide area network (WAN) such as the Internet, mobile network, or any other type of network) via a network interface connection. The input and output device(s) may be locally or remotely connected (e.g., via the network) to the computer processor(s), memory, and storage device(s).

One or more elements of the aforementioned computing system may be located at a remote location and connected to the other elements over a network. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

What is claimed is:

1. A system for providing nearby accounts, comprising:
a computer processor;
a live discovery module executing on the computer processor and configured to enable the computer processor to:
receive, from a client device, a request for nearby accounts, the request identifying a context account of a social media platform and a corresponding client geographic location;
identify a set of accounts of the social media platform within a density-based geohash region corresponding to the client geographic location;
rank the set of accounts according to:
a plurality of geographic distance tiers, wherein the geographic tiers are used to categorize the set of accounts based on a distance between the client geographic location and each account's geographic location,
a plurality of recency tiers, wherein the recency tiers are used to categorize the set of accounts based on a recency of each account's geographic location data,
a plurality of accuracy tiers, wherein the accuracy tiers are used to categorize the set of accounts based on an accuracy level of each account's geographic location data;
generate, based on ranking the set of accounts, a result set identifying a subset of the set of accounts; and
provide the result set in response to the request.

2. The system of claim 1, wherein the live discovery module further comprises functionality to remove accounts from the set of accounts that are beyond a maximum geographic distance threshold, are beyond a maximum recency threshold, and have requested to be undiscoverable.

3. The system of claim 1, wherein identifying the set of accounts of the social media platform further comprises identifying a set of accounts of the social media platform within a set of geohash regions proximate to the current geohash region.

4. A method for providing nearby accounts, comprising:
receiving, from a client device, a request for nearby accounts, the request identifying a context account of a social media platform and a corresponding client geographic location;
identifying a set of accounts of the social media platform within a density-based geohash region corresponding to the client geographic location;
ranking the set of accounts according to:
a plurality of geographic distance tiers, wherein the geographic tiers are used to categorize the set of accounts based on a distance between the client geographic location and each account's geographic location,
a plurality of recency tiers, wherein the recency tiers are used to categorize the set of accounts based on a recency of each account's geographic location data,
a plurality of accuracy tiers, wherein the accuracy tiers are used to categorize the set of accounts based on an accuracy level of each account's geographic location data;
generating, based on ranking the set of accounts, a result set identifying a subset of the set of accounts; and
providing the result set in response to the request.

5. The method of claim 4, further comprising removing accounts from the set of accounts that are beyond a maximum geographic distance threshold, are beyond a maximum recency threshold, and have requested to be undiscoverable.

6. The method of claim 4, wherein identifying the set of accounts of the social media platform further comprises identifying a set of accounts of the social media platform within a set of geohash regions proximate to the current geohash region.

7. A method for organizing hangouts, comprising:
receiving, from a first user, a hangout definition comprising a hangout time, a hangout duration, a hangout location, a public designation, and a set of invited participants;
sending invites to the invited participants on behalf of the first user;
receiving confirmation from a subset of the invited participants and designating the subset of the invited participants as confirmed participants;
receiving a request for nearby content from a second user not among the set of invited participants;
identifying a set of users based on proximity to a device of the second user;
determining that a subset of the users are among the set of confirmed participants;
grouping the subset of the users with data associated with the hangout definition; and
providing, in response to the request, the grouped subset of the users and the data for display in a user interface of the second user.

8. The method of claim 7, further comprising:
receiving, from the second user, a request to join the hangout;
adding the second user to the set of confirmed participant; and
grouping the second user with the subset of users in response to a second request for nearby content.

9. The method of claim 7, wherein grouping the subset of the users comprises determining that a current time is within a predefined window of the hangout time.

10. The method of claim 7, further comprising:
receiving, from a first user, a hangout definition comprising a time, a duration, a hangout location, a public designation, and a set of invited participants;
sending invites to the invited participants on behalf of the first user;
receiving confirmation from a subset of the invited participants and designating the subset of the invited participants as confirmed participants;
receiving a request for nearby content from a second user not among the set of invited participants;
identifying a set of content items based on proximity to a device of the second user, wherein the set of content items comprises users and a future hangout object associated with the hangout definition, and wherein identifying the future hangout object is based on a current time being within a predefined time window prior to the hangout time;
ordering the content items based on the proximity; and
providing, in response to the request, the ordered content items for concurrent display in a user interface of the second user.

11. The method of claim 7, further comprising:
determining that the hangout time is within a second predefined time window prior to the hangout time;
generating a shoutout corresponding to the hangout, the shoutout designating a non-user account of a location-based social media platform as an author and the shoutout geotagged to the hangout location;
broadcasting the shoutout to the location-based social media platform, wherein the shoutout is served to client devices based on proximity of the client devices to the hangout location, and wherein the shoutout is selectable by users to display the hangout definition and to join the hangout.

12. A system for organizing hangouts, comprising:
a computer processor;
a hangouts organization module executing on the computer processor and configured to enable the computer processor to:
receive, from a first user, a hangout definition comprising a hangout time, a hangout duration, a hangout location, a public designation, and a set of invited participants;
send invites to the invited participants on behalf of the first user;
receive confirmation from a subset of the invited participants and designating the subset of the invited participants as confirmed participants;
receive a request for nearby content from a second user not among the set of invited participants;
identify a set of users based on proximity to a device of the second user;
determine that a subset of the users are among the set of confirmed participants;
group the subset of the users with data associated with the hangout definition; and
provide, in response to the request, the grouped subset of the users and the data for display in a user interface of the second user.
